(19) United States
(12) Patent Application Publication
(10) Pub. No.: US 2022/0154750 A1
(43) Pub. Date: May 19, 2022

(54) MALE PIN AND FEMALE HOUSING ASSEMBLY FOR THE AXIAL FITTING OF SHELVES TO ANGULAR, UNDULATING AND VARIABLE-GEOMETRY WALLS OF DISPLAY STANDS

(71) Applicant: Chung KWO TZUO, São Paulo (BR)

(72) Inventor: Chung KWO TZUO, São Paulo (BR)

(21) Appl. No.: 17/437,490

(22) PCT Filed: Mar. 9, 2020
(86) PCT No.: PCT/BR2020/050073

§ 371 Date: Sep. 9, 2021

(30) Foreign Application Priority Data
Mar. 15, 2019 (BR) 1020190050896

(51) Int. Cl. F16B 12/24; A47F 5/11; F16B 12/20

(52) U.S. Cl. CPC F16B 12/24; F16B 2012/103; F16B 12/20; A47F 5/11

(57) ABSTRACT

For the universal coupling of shelves (PR) that can be attached to display stands (D), using a single male pin assembly, one of the pins being in the form of a rod (6) and the other pin being in the form of a ball (13). Upon the axial lowering of the shelf (PR), the pins (6) or (13), secured to the sides of the front edge thereof, always reach the corresponding eye (11) or cup (14) of the female housing, which is in turn secured to the side wall (PA) of the display stand (D). According to the design, since the female housing can be secured at any angle, there is no need to stock pins with a coupling end configured for each desired geometry, it being sufficient to manufacture said pins (6) and (13) providing a universal coupling between the shelf (PR) and the display stand (D).

This descriptive report refers to a utility model patent application for an arrangement developed for male pin (which is attached at the ends of the front edge of the shelf) and also for female housing (which is attached correspondingly, on the walls of the display stand).

According to the design, the male pin comprises a coupling terminal in two constructive versions, one of them in shaft and the other in ball version. The female housing, in turn, is correspondingly shaped in a version with an eye (for the shaft operation) and a version with a cup (for the ball operation)

Thus, in versions, both by the shaft and by the ball (male pins), it is possible to attach the shelf directly, at any positioning angle where the eye or cup (female housings) are attached on the wall of the display stand, regardless of the geometry of the latter.

According to the design, the shelf can be coupled, for example, to round-shaped display stands, where the housings are arranged at diametric points on the wall and, therefore, at a non-perpendicular angle in relation to the edge of the shelf. The shelf coupling can actually be carried out in variable geometry angles of the display stands walls, whether trapezoidal, oval, round, semi-circle, undulating and others, as the male pin—shaft or ball, as it is pivotal by the eye or cup, it will always reach the female housing. The shelves can also have a different geometric shape from the display stand itself, and can be designed, for example, for positioning with one of its sides in setback, for purposeful misalignment attachment on the side wall (of the display stand), with the pins at an angle, also enabling total flexibility of coupling for any display stand with this type of axial shelf locking (by pin and housing).

As another consequence, of equal importance, it avoids the need for the designer to produce and keep male pins with coupling terminals of different angles in stock for these display stands with different geometry, since the coupling, according to the design to be described, becomes universal, exceeding the currently allowed mounting limitation, which is only from the perpendicular coupling.

### TECHNICAL STATUS

As it is known, in specific models of display stands (cardboard or combining other materials), from the rear wall the parallel side walls are extended perpendicularly forming a rectangular geometry structure open frontally, along whose height the shelves are attached. From the rear wall, the shelves are hinged and, through male pins arranged at the ends of their front edges, coupling occurs in a perpendicular direction to lock with the female housings, correspondingly attached on the parallel side walls.

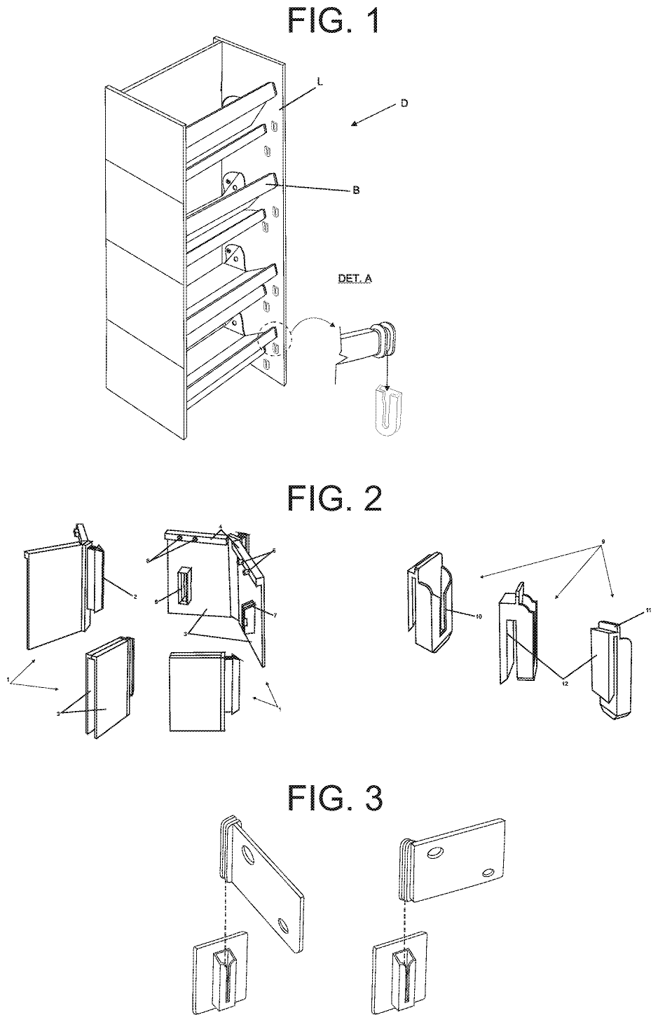

FIG. 1 shows an already publicly known configuration of a pin and housing, where the male pin has a laminar body with a coupling terminal that slides and accommodates axially on a perpendicularly arranged female housing rail, locking the shelves on the side walls when structuring the display stand at the point of sale. This FIG. 1 was taken from document PI 1104563-9 filed by the same inventor of the application to be described later.

A notable evolution in this configuration mentioned above is shown in FIG. 2 of the application to be described below, also filed by the same inventor, with images taken from the document PCT BR 2017 050068. As shown in FIG. 2, the same inventor created for the female housing a rear clip configuration whereby it is simply hooked into the sidewall (already assembled) exposing its rail. For the male pin shown on the side, in this same FIG. 2, the same inventor created a jaw configuration with a coupling terminal in an arrow configuration, extended from a front stop that delimits two fins that can be locked together by grooves, in order to fasten the side edges of the front edge of the shelf (already assembled), attaching the coupling terminal of the male pin.

It so happens that the current display stands, through innovative cut and crease designs, have been gaining countless shapes (not only rectangular), such as round, oval, semi-circle, multiple sinuosity and other geometric shapes, and the female housing is then attached as follows the angle different from the wall where it is attached, being, in this case, exposed in order to prevent the traditional perpendicular coupling of the male pin coupling terminal upon axial lowering of the shelf.

This makes the producer to design the coupling terminal of male pin at an angle compatible with the angle at which the female housing is exposed in order to the coupling can be made. As a consequence, the producer must have, in his stock, lots of male pins with coupling terminals at various angles so that the coupling reaches female housings attached according to the angulation of the walls of these display stands with different geometric shapes, whether circular, semi-circle, undulating and etc.

FIG. 3 also shows, as an example, this condition, of a pin produced with a perpendicular coupling terminal and, to the side, a pin produced with an angled coupling terminal, both specific for different geometries, so that they reach the respective female housings upon axial lowering of the shelf, during the structuring of the display stand at the point of sale.

### PURPOSE OF THE PATENT

The same inventor of these applications cited, PI 1104563-9 and PCT BR 2017 050068, has now proposed a system for coupling the male pin, attached to at least one of the ends of the front edge of the shelf, operating with one of the female housings, attached to the wall of the display stand body. By the proposal, the shelf and the display stand body can be designed in any desired configuration because, upon axial lowering of the shelf, through the male pin in shaft or ball configuration, the coupling is directed to reach the eye or cup of the female housing, regardless of the angle they are attached (on the shelf and on the display stand wall).

In this way, a single pin coupling/eye will universally meet any geometry of display stand without the need for the production and stock of male pins with specific coupling terminals for each model.

Superficially explained, the assembly of coupling of shelf to wall of display stands will be better detailed.

FIGS. 1, 2 and 3, as said above, refer to the technical status.

The following related Figures from 4 to 13 refer to the application in question:

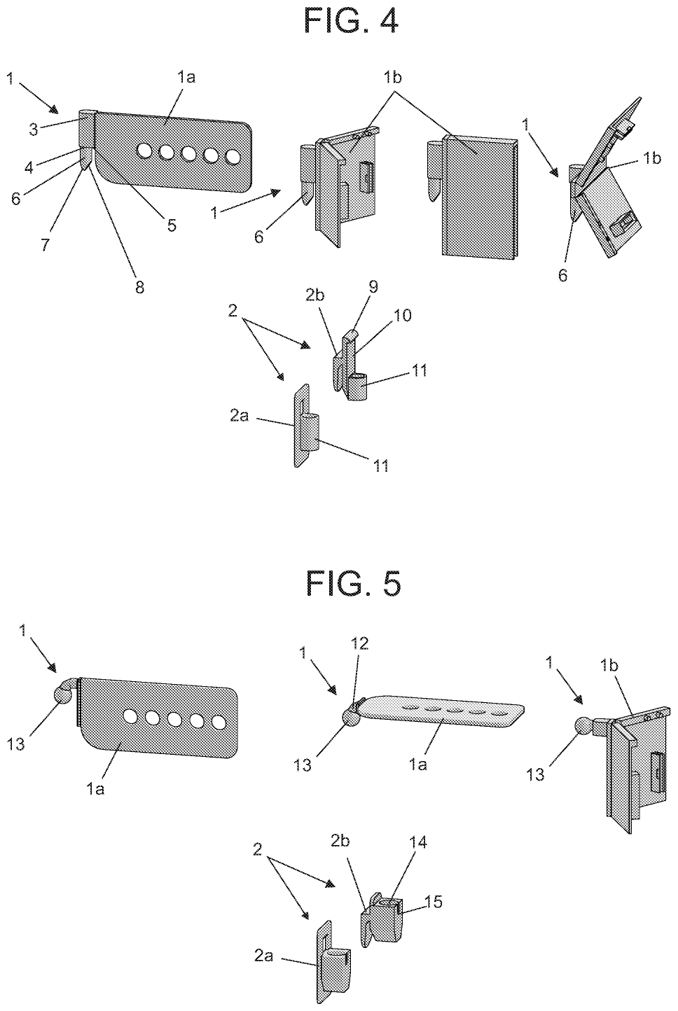

FIG. 4—perspective views of the cylindrical shaft male pin in three different configurations, for attachment to the ends of the front edge of the shelf. On the left, the male pin of cylindrical shaft with laminar body for vertical attachment is shown, in the center, the male pin of cylindrical shaft in jaw configuration, open and closed, for vertical attachment and, on the right, the male pin of cylindrical axis in open-jaw configuration for horizontal attachment. Below, two configurations of the female housing are shown, one being laminar and the other in a clip configuration, both equipped with an eye for the work of the male pin with a cylindrical shaft;

FIG. 5—perspective views of the male ball pin, in three different configurations for attaching at the ends of the front edge of the shelf. On the left, the male ball pin with laminar body for vertical attachment is shown, in the center the male ball pin with laminar body for horizontal attachment and, on the right, the male ball pin in jaw configuration, open, for vertical attachment. Below, two configurations of the female housing are shown, one of them being laminar and the other in a clip configuration, both equipped with a cup for the work of the male ball pin;

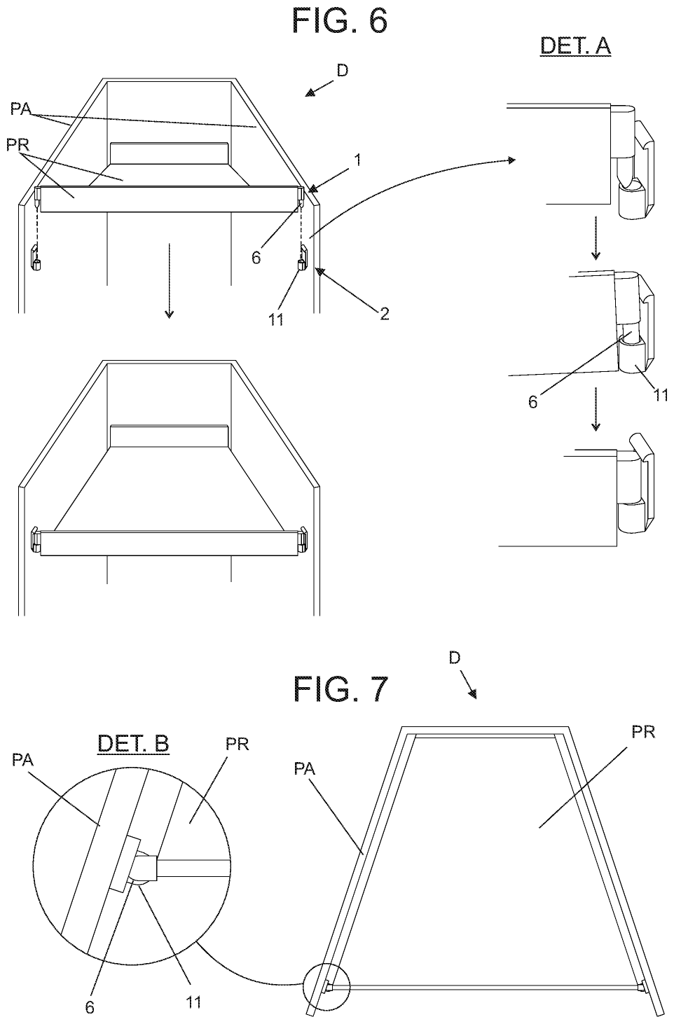

FIG. 6—it shows frontally, in partial perspective, a display stand with trapezoidal shape whose walls at an open angle from the back, receive their female housings, which are attached in such a way as to follow this angle of said walls. The shelf is found in axial lowering. As noted, coupling occurs, as shown in the enlarged detail sequence A, thanks to the male pin of cylindrical shaft, even if the female housing is at an angle not perpendicular to the front edge of the shelf;

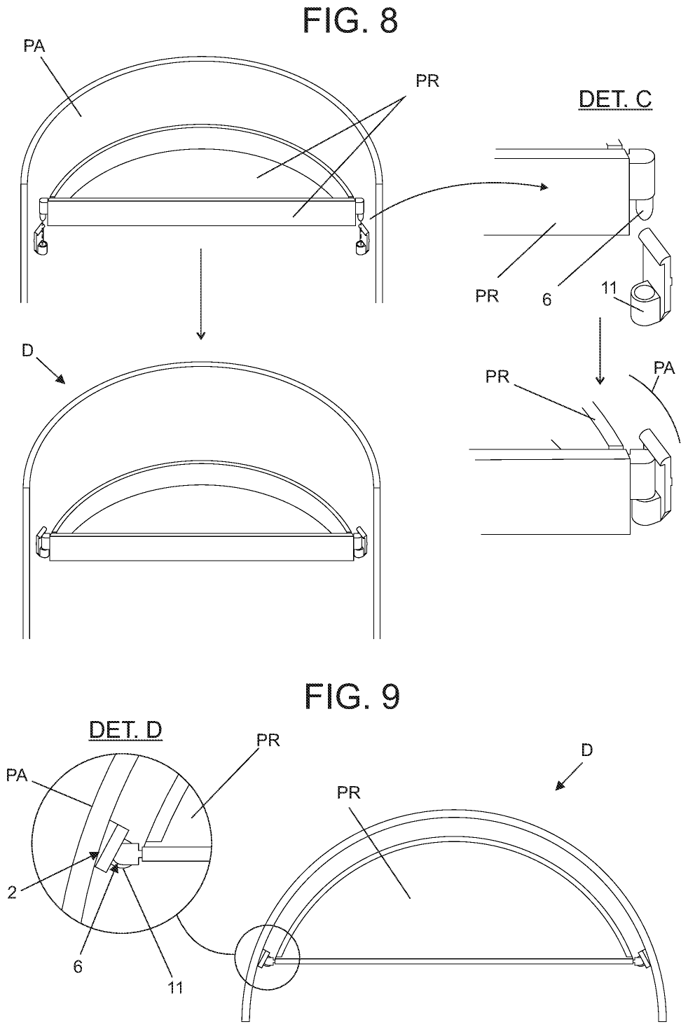

FIG. 7—shows the display stand with trapezoidal shape in top plan. On the side, in enlarged detail B, the coupling of the male pin of cylindrical shaft to female housing, positioned at an angle;

FIG. 8—it shows frontally, in partial perspective, a display stand with semi-circle shape with the walls provided with female housings equally at an angle not perpendicular to the front edge of the shelf. Coupling is carried out, as shown in the sequence of enlarged detail C, thanks to the male pin of cylindrical shaft that always reaches the eye.;

FIG. 9—shows the display stand with semi-circle shape in upper plan. On the side, in enlarged detail D, the coupling of the male pin of cylindrical shaft to female housing, positioned at an angle;

FIG. 10—it shows a rectangular display, but due to its design, it has a shelf with one of the sides in setback. The shelf, upon axial lowering, will have its pins, shaft or ball (in this case, the ball, shown in this figure), even if positioned at an angle, coupled to the female housings, as shown in the sequence in figure E;

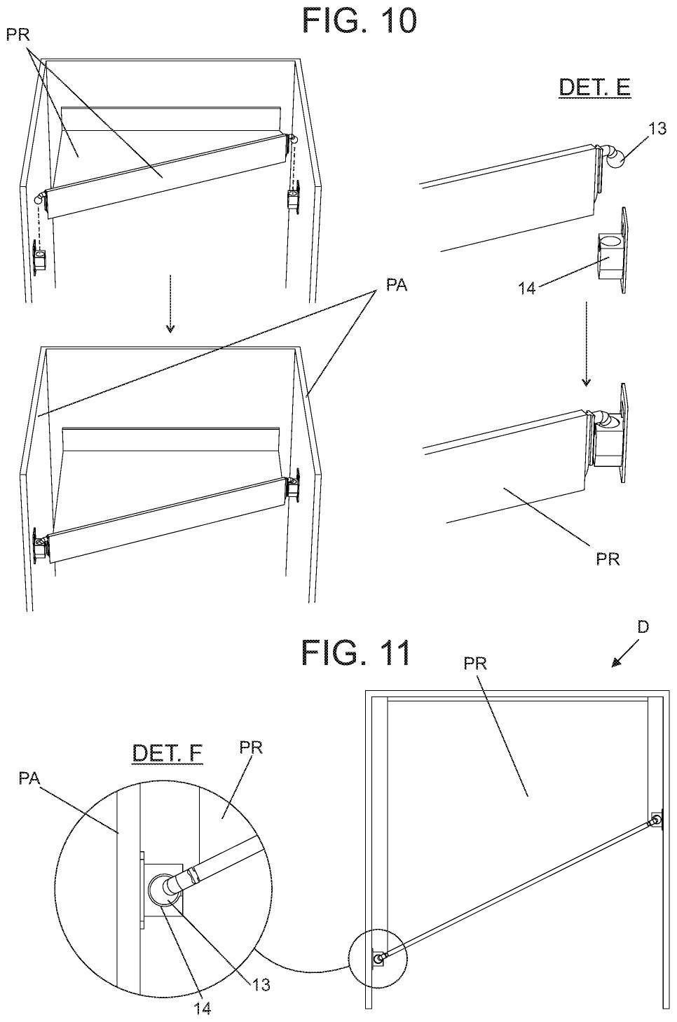

FIG. 11—shows the display stand with rectangular shape in top plan. The enlarged detail F shows the coupling of the male ball pin, at an angle, to female housing;

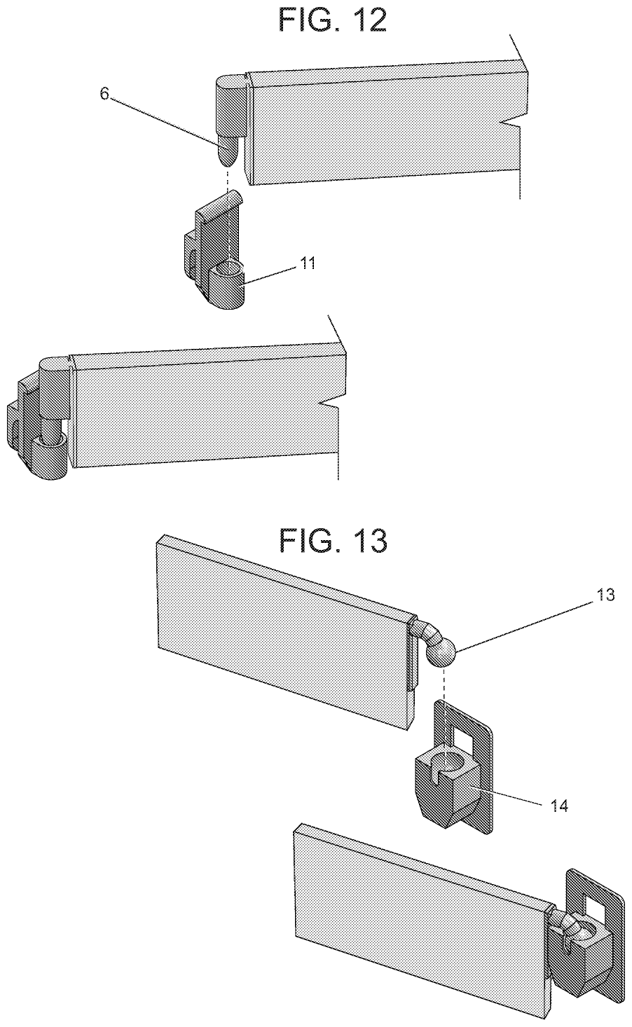

FIG. 12—shows the coupling of male pin with cylindrical shaft to female housing with eye, both at different angles to each other;

FIG. 13—shows the coupling of male ball pin to female housing with cup, both at different angles to each other.

According to the attached figures, o “MALE PIN AND FEMALE HOUSING ASSEMBLY FOR THE AXIAL FITTING OF SHELVES TO ANGULAR, UNDULATING AND VARIABLE-GEOMETRY WALLS OF DISPLAY STANDS” object of this present utility model patent application, it consists of shelf couplings assembly (P) in an display stand (D), composed, as shown in the figures ranging from 1 to 3, of the male pin (1) from the ends of the front edge (B) of the shelf (PR), either with a laminar body (1a) or with a jaw configuration body (1b) and for the female housing (2) of the display stand (D) wall (PA), either with a laminar body (2a) or body in clip configuration.

As a novelty, in a constructive version, as shown in FIG. 4, the male pin (1) receives a coupling terminal formed by a front stop (3) with a rounded edge, suffering, at an intermediate point (4), a slight reduction in diameter combined with a spacer section (5) from which a cylindrical shaft (6) with a rounded tip (7) extends inferiorly, however, with an inner edge slightly chamfered by a ramp (8), in order to distance this tip (7) suitably of said front stop (3). The male pin (1), in this constructive version of cylindrical shaft (6), works with the female housing (2) with a front face delimited by an upper edge (9) raised and lowered at an angle, followed by a flat section (10), of a lower eye (11).

In the other constructive version, as shown in FIG. 5, the male pin (1) receives a coupling terminal formed by a rod (12), curved or straight, at the end of which a ball (13) is incorporated. The male pin (1), in this second constructive ball version (13), works with the female housing (2) incorporating a cup (14) closed by its back (15).

For use, the male pin (1) must be attached to the end of the front edge of the shelf (PR) and the female housing (2) attached to the walls (PA) of the display stand (D).

As shown in FIG. 6 and its detail A, upon the axial lowering of the shelf (PR), equipped with the constructive version of male pin (1) with cylindrical shaft (6), this, by its ramp (8), exceeds and is coupled to the eye (11) of the female housing (2), leaning against the flat section (10) and prevented by the upper edge (9) from escaping. Through this coupling, regardless of the angle (not only perpendicular) in which the axis (6) of the shelf (PR) and the eye (11) of the wall (PA) are, the first element will always reach the second, in any geometry, (in this case shown, trapezoidal) in which the display stand assembly (D) is designed, as also shown in FIG. 7 and its detail B. FIGS. 8 and 9 show, together with their details C and D, the coupling to a display stand (D) with semicircle shape.

The same occurs upon the axial lowering of the shelf (PR), equipped with the constructive version of male pin (1) with ball (13), which is coupled to the dished bottom (15) of the cup (14) of the female housing (2), without escaping. Through this coupling, regardless of the angle (not only perpendicular) in which the ball (13) and the cup (14) are, the first element will always reach the second, in any geometry in which the display stand assembly (D) is designed. FIGS. 10 and 11 and their details E and F, show the shelf (PR) with one of the sides in setback, in a display stand (D) with rectangular shape.

Therefore, through this constructive arrangement, always using the same pins—shaft (6) or ball (13), the shelf (PR) can be designed to meet display stand with any geometric shape (D), from oval, semi-circle, undulating, staggered and others. It can, for example, be positioned at any depth of the wall (PA) of the display stand (D), with one side in setback for purposeful misalignment, and thus meet display stands with any geometric (D) shape, as the shaft (6) or ball (13) male pin will always reach and couple to the female housing eye (2) or cup (14), as shown in FIGS. 12 and 13.

1- “MALE PIN AND FEMALE HOUSING ASSEMBLY FOR THE AXIAL FITTING OF SHELVES TO ANGULAR, UNDULATING AND VARIABLE-GEOMETRY WALLS OF DISPLAY STANDS, where, in displays stands (D), the male pin (1) of the shelf (PR), either with a laminar body (la) or with a jaw configuration body (lb) and the female housing (2) of the corresponding wall (PA), either with a laminar body (2a) or with a body in clip configuration (2b), are characterized by, in a constructive version, the male pin (1) receives a coupling terminal formed by a front stop (3) with a rounded edge, suffering, at an intermediate point (4), a slight reduction in diameter combined with a spacer section (5) from which a cylindrical shaft (6) with a rounded tip (7) extends inferiorly, however, with an inner edge slightly chamfered by a ramp (8), in order to distance this tip ( 7) suitably of said front stop (3). The male pin (1), in this constructive version of cylindrical shaft (6), works with the female housing (2) with a front face delimited by an upper edge (9) raised and lowered at an angle, followed by a flat section (10), of a lower eye (11)

2- “MALE PIN AND FEMALE HOUSING ASSEMBLY FOR THE AXIAL FITTING OF SHELVES TO ANGULAR, UNDULATING AND VARIABLE-GEOMETRY WALLS OF DISPLAY STANDS, according to claim 1, in another constructive version, the male pin (1) and the corresponding female housing (2) are characterized by the male pin (1) receiving coupling terminal formed by a curved rod (12) incorporating, at the free end, a ball (13), said male pin (1), in ball configuration (13), working with the female housing (2) that incorporates frontally, a cup (14) with a dished bottom (15).
